(19) United States
(12) Patent Application Publication
(10) Pub. No.: US 2009/0100032 A1
(43) Pub. Date: Apr. 16, 2009

(54) METHOD AND SYSTEM FOR CREATION OF USER/GUIDE PROFILE IN A HUMAN-AIDED SEARCH SYSTEM

(75) Inventors: Scott A. Jones, Carmel, IN (US); Thomas E. Cooper, Indianapolis, IN (US)

Correspondence Address: STAAS & HALSEY LLP, SUITE 700, 1201 NEW YORK AVENUE, N.W., WASHINGTON, DC, 20005, US

(73) Assignee: ChaCha Search, Inc., Carmel, IN (US)

(21) Appl. No.: 12/250,267

(22) Filed: Oct. 13, 2008

Related U.S. Application Data
(60) Provisional application No. 60/979,565, filed on Oct. 12, 2007.
(60) Provisional application No. 60/980,010, filed on Oct. 15, 2007.

(51) Int. Cl. G06F 17/30; G06Q 30/00

(52) U.S. Cl. 707/4; 705/14; 707/5; 707/E17.014; 707/E17.136

(57) ABSTRACT

A process and system of defining a user and/or guide profile is disclosed. Information of a user or guide profile may be obtained by designating information to be processed by a search system. Profile data may be obtained from a number of activities which produce information regarding a person who participated in the activities. A process and system is provided for creating profiles which may be used to identify persons who have information related to the profile. A searcher, user or other profile may be created, modified and managed using the process and system.

### CROSS-REFERENCE TO RELATED APPLICATIONS

This application is related to and claims the benefit of U.S. Provisional Application Ser. No. 60/979,565, entitled, “METHOD AND SYSTEM FOR CREATION OF USER/GUIDE PROFILE IN A HUMAN-AIDED SEARCH SYSTEM”, by Scott A. Jones, et al., filed Oct. 12, 2007 in the U.S. Patent and Trademark Office, and U.S. Provisional Application Ser. No. 60/980,010, entitled “METHOD AND SYSTEM FOR MATCHING INFORMATION SEEKERS AND SEARCHERS”, by Scott A. Jones et al., filed Oct. 15, 2007 the contents of which are incorporated herein by reference.

### BACKGROUND

1. Field

The present invention is related to search systems and specifically search systems utilizing human searchers and, more particularly, to creating a profile which may be associated with a guide (or searcher), a user (or information seeker), and/or groups of guides and/or users. A method for characterizing information providers and information seekers is disclosed.

2. Description of the Related Art

In general search engines are keyword driven systems. Keywords are generated from a user request and matched to target documents, advertisements, etc. This practice is well established by such services as Google® or Dogpile®. In some instances a user may elect to create a personal login. The data provided by a user may include such information as name, address, etc. which may be used to improve the relevancy of search results. When a search service provides other services such as email (e.g., Gmail®), or financial services (e.g., Yahoo® Finance), the contents of some documents or files may be processed in order to determine common associations of keywords using various techniques, or the content of a user profile provided is used to personalize and target search results and advertisements. When a query is submitted by a logged-in user, a keyword(s) of a query may be used to find documents which may contain keywords which are associated with any or all of the keywords of a query based on an examination of email, a blog, a list of favorites, etc, associated with a user, and/or information contained in a user profile.

In a similar manner, a mobile search system may gather data about a user based upon local data of a user device, a user profile from a service provider of wireless and/or wired communication services, a transaction history, etc. In any case, data may be gathered based upon user input, from data obtained by a service provider, or implicit data of a user device (e.g., caller ID, IP address, GPS data, change in location, files stored and/or transmitted to and/or from the device, etc.).

Such user profiles are typically limited by an amount of information which a user is willing to provide to a service provider. Because some types of profile data may be easily associated with a user (e.g., name and address), and may be stored in a database which is inaccessible to or outside the control of a user, users may provide limited information to a search engine provider due to privacy or other issues.

In the case of a human-assisted search engine, techniques such as those used to create a user profile in a conventional search engine may be employed to create a guide profile. However, existing methods have limited utility for this application. For example, while a person may currently live in Chicago (as indicated by a user profile, telephone account, etc,), he or she might have lived in or traveled to other cities about which he or she may be more knowledgeable. Likewise, a searcher (guide) may be an experienced woodworker, but not be employed in that profession. As such, skills and/or knowledge which could be helpful to an information seeker may not be made available. A guide might have skills or competencies of which he or she is unaware, or which he or she feels are not of interest to others, which could provide an opportunity for a guide if made known to other guides and/or users of a human-assisted search system.

In light of the above a system and method for creating, editing and sharing a guide and/or user profile would be greatly appreciated.

### SUMMARY

A method and system for creating and editing a guide and/or user profile for a human-aided search system is disclosed. The disclosed system and method allow a user and/or a guide to create and edit a profile which may be used to aid communication between a user(s) and/or a search system and/or a guide(s).

The disclosed system and method include capturing a characteristic of a person by parsing content identified with the person and generating a profile for the person based on said capturing and selecting data to be associated with a search based on the profile.

The method includes identifying a person, obtaining information associated with the person, processing the information to determine a characteristic of the person, determining a rating of the person associated with the characteristic, and associating the characteristic and the rating with an identifier of the person.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of a system embodiment.

FIG. 2 illustrates a graphical user interface (GUI) for user registration.

FIGS. 3A and 3B illustrate exemplary GUIs for guide (searcher) registration.

FIG. 4 illustrates a searcher profile record.

FIG. 5 illustrates a user profile record.

FIG. 6 is a flow diagram depicting a process of managing a profile.

FIG. 7 is a flow diagram depicting a process of managing a profile.

FIG. 8 illustrates an exemplary GUI for editing a guide or a user profile(s).

FIG. 9A illustrates an exemplary GUI for designating resources to be indexed.

FIG. 9B illustrates an exemplary GUI for selecting a location and a type thereof.

FIG. 9C illustrates an exemplary GUI for selecting activities or sessions.

FIG. 10 is a flow diagram depicting a process of customizing a profile.

FIG. 11 illustrates a parametric profile record.

FIGS. 12A-12B illustrate exemplary GUIs for creating and modifying a profile.

### DETAILED DESCRIPTION OF THE PREFERRED EMBODIMENTS

Reference will now be made in detail to the present embodiments discussed herein, examples of which are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate.

Generally, systems which refer queries to experts or human assistants include an index which is used to associate a search request with one or more human assistants. For example, a person might be associated with a keyword and/or a category which may be associated with a request which is then used to select a person with the needed skills to respond to the request. In the new system, a person is associated with an index which may not be related to the content of a request. A ‘profile’ or set of characteristics of a person is obtained which are independent of the content of a request, and may not be specifically related to information required to respond to a user request.

A user and/or a guide may be associated with one or more characteristics by the search system. A characteristic may include demographic, geographic, psychometric, affiliation, certification, social, or other types of characteristics which may be identified by the search system. A group of characteristics or ‘profile’ is associated with a user or a guide. A profile may be created which is not associated with a specific person, which may be used to select a group of persons.

Graphical user interfaces and a system embodiment(s) for creating and editing a profile(s) are disclosed.

In order to create a guide or user profile, an initial account may be established for a user or guide. A profile may be created using a limited data set, which could be as simple as a login ID and a password. A profile might include more detailed information in the case where a person or entity is compensated for information search activities. A guide (searcher) profile might include items required by government authorities, etc. Required information might include taxpayer ID number, residence, legal name, etc. As a guide may receive payment(s), access information of a payment account could be required. A search system (or service) provider might require information in order for a guide to be registered with the search system. For example, the search system may require a guide to provide information which may be indicated in a profile of the guide, or information provided as part of a registration process may be used to determine profile information associated with a guide.

Once a guide or searcher and/or a user or information seeker or requester is registered with the search system, the guide and/or user may add information to a profile. Profile information may be obtained using media indicated by a user and/or a guide. A published work(s), content(s) from a server, audio, video, image and/or media files in a storage device, a resume, employee database(s), etc. might be used. For example, information from a website such as a MySpace® or LinkedIn® profile page might be utilized to obtain profile information.

Profile information may be obtained using an interactive session(s). A person may participate in interactive sessions such as a poll, a test, a game, a training session, or other activities which may provide profile information. For example, a guide might be given a personality test to determine characteristics such as aggressiveness, risk tolerance, optimism, etc. as might be used by a service such as Match.com® or eHarmony®.

As information is added to a profile, it may be desirable to edit the profile. A person may be able to modify content of a profile. A profile which is not associated with a specific person may be created and maintained.

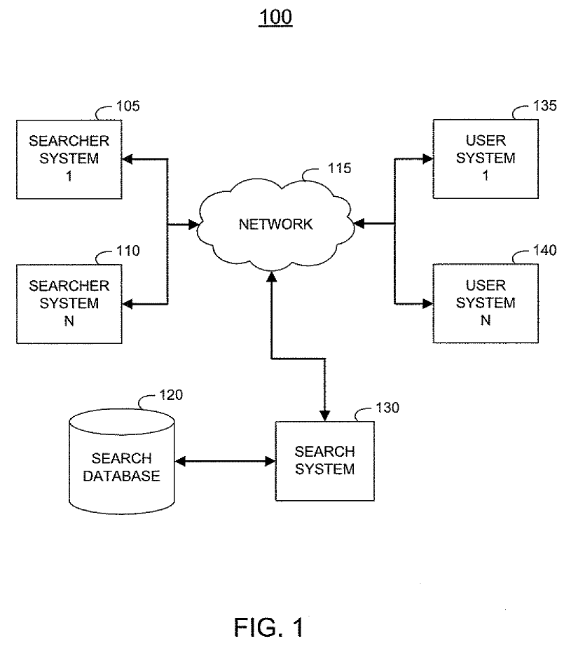

As illustrated in FIG. 1, in at least one embodiment, system 100 is provided. The system 100 includes a searcher system 105, a searcher system 110, a network 115, such as the Internet, a search system 130, a user system 135, a user system 140, and a search system database 120, which may comprise various records.

Each of the searcher systems, that is, the searcher systems 105, 110 can be operated by a human searcher to obtain search results for an information seeker located at user systems (e.g., the user systems 135, 140). While only a limited number of searcher and information seeker (also referred to as a user or Infoseeker™) systems are depicted in FIG. 1, it is within the scope of the disclosure for multiple searcher and information seeker systems to be utilized.

The network 115 (FIG. 1) may be a global public network of networks (the Internet) or consist in whole or in part of one or more private networks and communicatively couples the searcher systems and user systems with the other components of the system such as the search system 130, and the search database 120.

The search system 130 allows interaction to occur between the searcher systems 105, 110 and the user systems 135, 140. For example, an information search query(ies) can be transmitted from the user systems 135, 140 to the search system 130, where a query(ies) can be accessed by the searcher systems 105, 110. Similarly, a search result(s) produced using the searcher systems 105, 110 in response to a search query(ies) submitted by the user systems 135, 140 may be transmitted to the search system 130, where they may be stored by the search system 130 and may be transmitted to the user systems 135, 140.

The user systems 135, 140 may include, within the scope of this disclosure, any device through which an information seeker can submit a query to and/or receive a result(s) from the search system 130. In one embodiment, the user system 135 may be a device configured for connection to a network and may run web browser software. Thus, the user system 135 may be a laptop, personal data assistant, desktop PC or Mac®, a workstation or terminal connected to a mainframe, or a smart phone, etc. within the scope of the disclosure herein. The search system 130 may include a gateway for voice communication and a speech-to-text system or other transcription device or personnel to facilitate access to the search system via voice communications such as through a land line phone, cellular phone, voice over Internet protocol or other telephonic device. Such devices are also information seeker systems within the scope of this disclosure.

The search system 130 is communicatively coupled with the database 120. As will be described herein in further detail below, the database 120 includes data that is processed in association with operation(s) of the embodiments. Although FIG. 1 illustrates the database 120 as a separate component of the system, the database 120 may be integrated with the search system 130. Further, the records maintained in the database 120 may be stored in any typical manner, including in a Network Attached Storage (NAS), a Storage Area Network (SAN), etc. using any typical or proprietary database software such as DB2®, Informix®, Microsoft® SQLServer™, MySQL®, Oracle®, etc., and may also be a distributed database on more than one server. Elements of the database 120 may reside in any suitable elements of the system 100.

The user systems 135,140, the guide systems 105,110, and/or the search system 130 may include equipment and personnel required to send and/or receive messages between a user system, a guide system and/or the search system using the network 115. For example, a guide system(s) may be utilized for speech-to-text transcription, a user system may include text-to-speech conversion capabilities, or automated conversion of text to speech or speech to text may be performed. The database 120 includes information which may allow the search system 130 to establish communication between the other elements of the system.

A user system, and/or a guide system may be a desktop or laptop PC or Mac®, a mobile phone, a smart phone, a PDA, a server system, a landline phone, a specialized communication terminal, a terminal connected to a mainframe, or any other communication device. The search system 130 may include one or more servers, computers, etc. After being presented with the disclosure herein, one of ordinary skill in the relevant art will immediately realize that any viable computer system(s) or communication device(s) known in the art may be used as user systems, guide systems, and/or to implement the search system 130. A communication session between a user system(s), a guide system(s) and/or the search system 130 may be conducted using communication services such as short messaging service (SMS), enhanced messaging service (EMS), multimedia messaging service (MMS), instant messaging (IM), voice, voice over Internet protocol (VoIP), email, internet, and/or other services associated with a user device(s).

In the disclosed system and method the guides or searchers may be required to register with the search system 130, and in certain embodiments undergo training or participate in other activities prior to being permitted to provide responses to queries submitted by an information seeker(s) or user(s) utilizing the search system 130. In at least one embodiment, a prospective guide or searcher may be invited to register as a searcher with the search system 130. In such a system, a previously registered searcher or an affiliate group may initiate the invitation process and thereby be designated as a sponsor for the invited searcher. In at least one embodiment of the disclosed system and method, a prospective guide is sent an invitation to register as a guide or searcher with the search system 130. For example, an email invitation containing a link to a guide registration page and some indicia recognizable by the search system 130 as to the person or entity that invited a prospective guide to register may be provided, so that upon registration the person or entity may be accredited with sponsorship of the invited guide.

Should a prospective guide elect to register as a guide with the system, the prospective guide may for example initiate a registration process by clicking on a link that directs the prospective guide's web browser to a URL of a guide registration page generated by a web server function of the search system 130. The search system 130 may generate a registration web page designed and configured to allow a prospective searcher or guide to enter information for registration as a guide with the search system 130, as will be described herein below.

A user may be required to register with the search system 130. A user may be requested to provide a set of identifying information such as a user ID and a login password. A user may be requested to provide information as a condition for accessing services provided by the search system 130 (FIG. 1). Profile information associated with a user may be associated with a unique identifier assigned to the user login ID. A user is any person who may submit a request for information to the search system 130. In at least one embodiment, a user may be associated with a mobile phone number which may be associated with a unique identifier of the user.

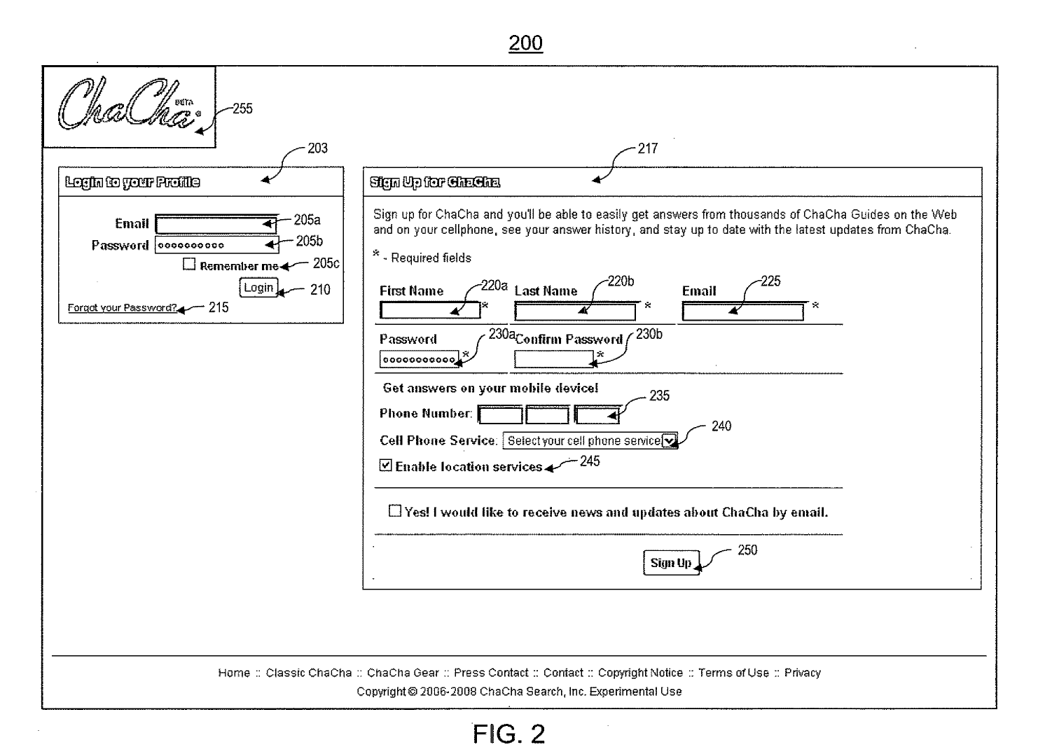

An exemplary GUI 200 for registration with the search system 130 (FIG. 1) is illustrated in FIG. 2.

The GUI 200 may include a user login window 203, user login controls 205, a login button 210, a password recovery control 215, a user sign up window 217, name entry boxes 220, an email entry box 225, password selection controls 230, a phone number entry box 235, a cell phone provider selection control 240, a location services selection box 245, and a sign up control 250.

The ‘email’ user login control 205a may be used to enter an email address associated with a user account with the search system. The ‘password’ login control 205b may be used to enter a password associated with a user account. The ‘remember me’ login control 205c may be used to cause a user password to be retained for future visits to the webpage. The login button 210 may be used to submit the information indicated in the user login controls 205 to the search system 130 (FIG. 1). The password recovery control 215 may be used to recover a forgotten password.

The user sign up window 217 may be used to register a user with the search system 130 (FIG. 1). The ‘First Name’ name entry box 220a may be used to indicate a first name of a user. The ‘Last Name’ name entry box 220b may be used to indicate a last name of a user. The email entry box 225 may be used to indicate an email address to be associated with a user account. The ‘Password’ password selection control 230a may be used to enter a requested password to be associated with a user account. The ‘Confirm Password’ password selection control 230b may be used to confirm a requested password. The phone number entry box 235 may be used to enter a 10-digit phone number. The cell phone provider selection control 240 may be used to select a phone service provider associated with a phone number indicated in the phone number entry box 235. The location services selection box 245 may be used to indicate whether a user elects to allow location services associated with a user device to be enabled. The sign up control 250 may be used to submit information indicated in the user sign up window 217 to the search system 130 (FIG. 1).

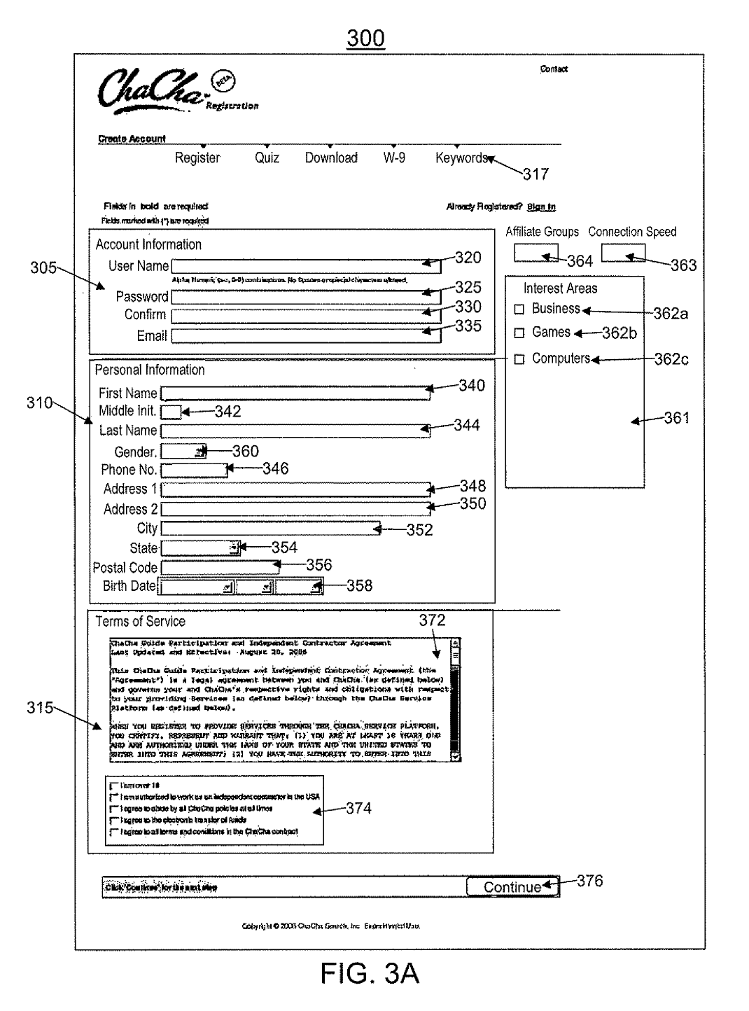

In the case of a guide, profile information may be required by the search system 130 as part of a registration process. An exemplary guide registration GUI is illustrated in FIGS. 3A-3B

FIG. 3A illustrates an example of a searcher or guide registration page 300 designed and configured to allow a prospective guide to enter information for registration as a guide with the search system 130 (FIG. 1) As illustrated in FIG. 3A the registration page 300 may be divided into an account information section 305, a personal information section 310 and a terms of service section 315. The account information section 305 and the personal information section 310 each may include a plurality of text boxes and/or drop-down lists for entry of data associated with a guide. A user identification (ID) text box 320 is provided for input of user ID information regarding a searcher. The user ID text box 320 may be automatically populated with a standardized form of user ID by utilizing data input in the personal information section 310. The content of the user ID text box 320 may for example, be automatically generated by selecting the text string entered in the first name text box 340 and the first letter of the text string entered in the last name text box 344 and appending a text string to differentiate the user ID from existing user IDs.

The password text box 325 may be used to provide a desired password. The password confirmation text box 330 may be used to confirm the password provided in the password text box 325. The email text box 335 may be used to provide an email address for a prospective guide.

The first name text box 340 may be used to provide first name information, the middle initial text box 342 may be used to provide middle initial information, and the last name text box 344 may be used to indicate last name information of a prospective searcher. The phone number text box 346 may be used to provide a phone number of a prospective guide. Preferably the phone number text box 346 requires entry of a ten-digit number including area code. Information provided using the phone number text box 346 may be used to determine a geographic location of a guide. The address text boxes 348, 350 may be used to provide address information. The city text box 352 may be used to provide city information. The state indicator 354 which may be a text box or preferably a drop-down list may be used to indicate state information of a prospective guide. The postal code text box 356 may be used to indicate a postal code. Address information provided in the GUI 300 may also be utilized to establish a geographic location for a guide. The date of birth indicator 358 which may be a text box or preferably a drop-down list(s) may be used to provide date of birth information. The gender indicator 360 may be used to indicate gender information.

The registration page 300 may include one or more affiliation selection list(s) 364 populated with a list of available affiliate groups to permit a prospective guide to indicate affiliate groups with which he or she may be associated. In at least one embodiment, an affiliate group may elect to provide a search box on an affiliate group web page so that queries presented via the web page may be directed, if possible, to members of the affiliate group, in which case the registration page provided to a prospective searcher may pre-populate the affiliation selection list(s) 364 with the name of a sponsoring affiliate group. In at least one embodiment, a prospective searcher is not permitted to indicate affiliation with one or more groups when directed to a registration page via an email invitation generated by an affiliate group request. In other embodiments, a prospective searcher may be able to select one or more affiliate groups in which he or she may be a member. Upon indicating membership in an affiliate group, the search system 130 (FIG. 1) may require verification information to validate a prospective searcher's membership in a selected affiliate group. Such information may include a user ID and/or a user password for an affiliate group. Any type of membership authentication information may be requested within the scope of the disclosure herein.

The registration page 300 may include the areas of interest selection window 361. A prospective searcher may indicate interest areas by activating an interest selection control 362 in the areas of interest selection window 361. For example, activation of the ‘Business’ interest selection control 362a, which may be indicated by a ‘check mark’, may be used by a searcher to identify ‘Business’ as an interest area. Likewise the interest selection controls 362b and 362c may be used to indicate interest in ‘Games’ and ‘Computers’, respectively. The selections made using the areas of interest check boxes 362 may be recorded in a profile of the searcher. The internet connection speed text box 363 which may a text box or preferably a drop-down list may be used to indicate a type of internet connection speed.

Prospective searchers may register with the search system 130 to accept search requests based on categories and/or keywords associated with a query. In at least one embodiment, selecting the ‘Keywords’ control 317 in the registration page 300 may cause the GUI 380 illustrated in FIG. 3B, to be provided.

The terms of service section 315 (FIG. 3A) may include the terms of service window 372 which may allow a prospective guide to view information of a service agreement for a guide. The consent check boxes 374 may be used to indicate assent to terms required for the service agreement indicated in the terms of service window 372. The ‘Continue’ control 376 may be used to submit information provided using the registration page 300 to the search system 130 (FIG. 1). The search system 130 may extract information from the registration page 300 and may store such data in the search database 120 (FIG. 1). Any information such as telephone number, address, gender, date of birth, affiliate group, areas of interest, etc. obtained in a registration process may be recorded in a profile of a guide which may be used to match a guide to a request.

While the registration web page 300 requests the information described, it is within the scope of this disclosure for any information to be requested in order to register as a searcher with the search system. One of ordinary skill in the relevant art will immediately recognize that while, text boxes, drop-down lists and check boxes are illustrated as being generated on the registration page 300 (FIG. 3A) to facilitate acquisition of required information from the searcher, other equivalent data input controls which are well known in the relevant art may be utilized. Information such as ethnicity, religious affiliation, institutes of higher learning attended, degrees earned, areas of study, etc. may be requested by the search system 130 and may be stored in a profile of a searcher(s). It is also within the scope of this disclosure for the information requested for registration as a searcher to be acquired in other ways such as by accessing cookies and/or information stored on a guide or user system, via a database dump from an affiliate group database, etc. Likewise the search system 130 may request that a guide identify any type(s) of information and/or resource(s) which may be used to obtain profile information. Information of a searcher may be obtained using various types of activities. For example, testing, polling, game-playing or other activities might be provided to a guide. Any or all information acquired regarding a searcher(s) may be recorded in the search database 120 (FIG. 1).

A GUI 380 for selection of keywords and categories is illustrated in FIG. 3B. The GUI 380 may be used to select a number of categories and keywords. The GUI 380 may include a taxonomy selection window 366, a keyword selection window 368, and a current keywords window 370. The taxonomy selection window 366 may include information regarding a taxonomy which is used to select a guide and/or other information. The category indicators 381 may indicate a category which may include one or more sub-categories. The ‘Reference’ category indicator 381a may be used to select keywords and subcategories associated with the category ‘Reference’, the ‘Regional’ category indicator 381b may be used to select keywords and subcategories associated with the category ‘Regional’, the ‘Science’ category indicator 381c may be used to select keywords and subcategories associated with the category ‘Science’, the ‘Shopping’ category indicator 381d may be used to select keywords and subcategories associated with the category ‘Shopping’. Activating a category indicator 381 may cause the subcategory indicators 382 associated with the category to be provided. Using the example in FIG. 3B, the ‘Shopping’ category indicator 381d is activated as indicated by the ‘-’ indicator, and the subcategory indicators 382 associated with ‘Shopping’ are provided. The subcategory indicators 382 may be used to provide information regarding keywords associated with a subcategory and category in the keyword selection window 368. Activation of the ‘By Region’ subcategory indicator 382a may cause keywords associated with the subcategory ‘Shopping>By Region’ to be provided in the keyword selection window 368, activation of the ‘Children’ subcategory indicator 382b may cause keywords associated with the subcategory ‘Shopping>Children’ to be provided in the keyword selection window 368, and activation of the ‘Classifieds’ subcategory indicator 382c may cause keywords associated with the subcategory ‘Shopping>Classifieds’ to be provided in the keyword selection window 368. As illustrated by the underline indicator in FIG. 3, the ‘Classifieds’ subcategory indicator 382c is selected. The navigation controls 389a may be used to navigate within the subcategory selection window 366.

The keyword selection window 368 may include information regarding a number of keywords for which a guide may elect to accept searches. The subcategory control 383 may be presented based on a subcategory selected using the subcategory indicators 382. More than one subcategory control may be presented in the keyword selection window 368. Activation of a subcategory control 383 may cause the keyword indicators 384 to be provided. For example clicking on the ‘Classifieds’ subcategory control 383 may toggle between the keyword selection controls 384 being displayed and being hidden. The keyword selection controls 384 may be used to identify a keyword which is to be added to a list of keywords associated with a searcher. Activation of the ‘advertising agencys’ keyword selection control 384a may cause the keyword ‘advertising agencys’ in the categorization ‘Shopping>Classifieds’ to be added to the current keywords window 370. Likewise the ‘affordable dog walk’ keyword indicator 384b and the ‘apartment for rent’ keyword indicator 384c may be used to add the respective categorized keywords to the current keywords window 370. Selection of a keyword selection control 384 may be indicated by for example the underline indication on the ‘apartment for rent’ keyword selection control 384c. The navigation controls 389b may be used to navigate within the subcategory selection window 368.

The current keywords window 370 may include information of keywords currently associated with a searcher. The current keyword indicators 385 may be used to indicate the status of a keyword and category associated with a searcher. A keyword may be removed from association with a searcher using the current keyword indicators 385. For example, the ‘x’ control associated with a current keyword indicator 385 may be activated to remove the keyword from the list of keywords for which a searcher will accept searches. A current keyword indicator 385 may include information of a category and subcategory associated with a keyword. The current keyword indicator 385a indicates that the searcher is associated with the keyword ‘computers’ and the category ‘Business>Accounting’, the current keyword indicator 385b indicates that the searcher is associated with the keyword ‘dictionary’ and the category ‘Business>Directories’, and the current keyword indicator 385c indicates that the searcher is associated with the keyword ‘employment’ and the category ‘Business>Directories’. The navigation controls 389c may be used to navigate within the current keywords window 370.

The sorting controls 390 may be used to change the sorting criteria for keywords displayed in the keyword selection window 368. Activation of the ‘Alphabetic’ sorting control 390a as indicated by the underline may cause the keywords to be presented in alphabetic order in the keyword selection window 368. Activation of the ‘Popular’ control 390b may cause the keywords to be presented in order of most frequent occurrence in search requests. The filter controls 387 may be used to filter the keywords presented in the keyword selection window 368. A word or phrase may be entered in the selection box 387a, and activation of the ‘Apply’ button 387b may cause only keywords including the word or phrase to be indicated in the keyword selection window 368. Activation of the ‘Add Keyword’ control 388 may cause a keyword selected using a keyword indicator 384 to be added to the current keywords window 370, and a list of keywords associated with a searcher. For example if the ‘apartment for rent’ keyword indicator 384c is selected as indicated by the underlining, clicking on the ‘Add keyword’ control 388 may transfer the selected keyword to the current keywords window 370.

Information acquired using the GUI 380 may be recorded in the search database 120 (FIG. 1) and may be used to select a guide based on the keywords and/or categories associated with the guide.

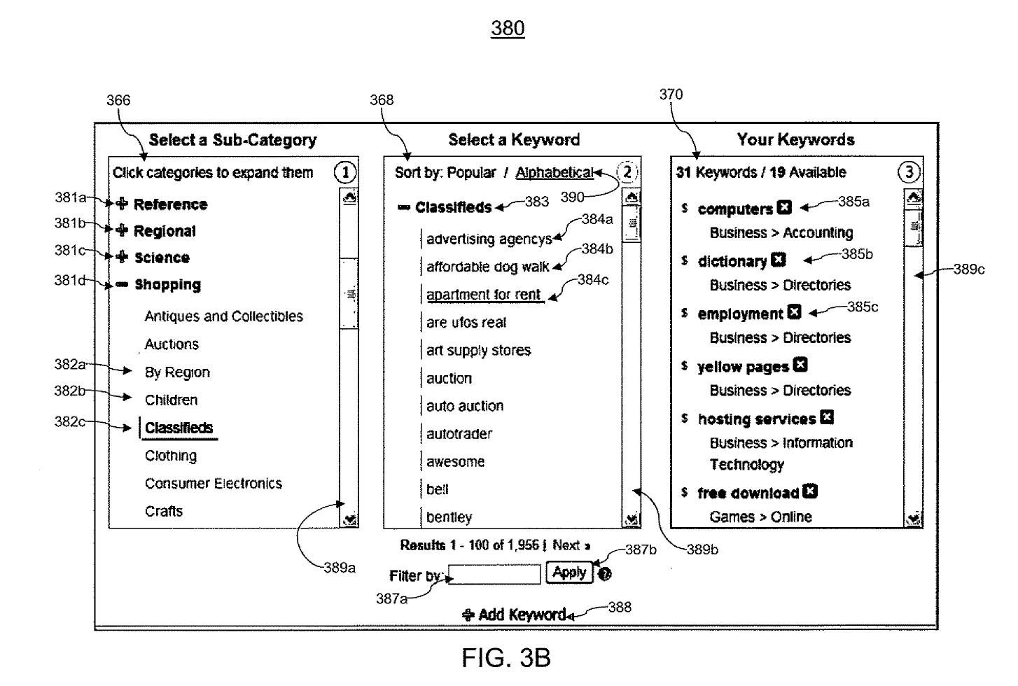

As illustrated in FIG. 4, an exemplary searcher profile record 400 of which one or more may be associated with or resident in the search system database 120 (FIG. 1) is provided. The searcher profile record 400 may comprise a searcher profile identifier (ID) field 405, a profile searcher ID field 410, a searcher demographic profile field 415, a searcher geographic profile field 420, a searcher personality profile field 425, and a searcher interest area profile field 430.

The searcher profile ID field 405 contains an identifier of the searcher profile record 400. The searcher profile ID is preferably unique and is used consistently to identify a searcher profile. The searcher profile ID field 405 may contain text and/or numeric information and may contain information based on a random number. The searcher profile ID field 405 serves to distinguish the searcher profile record 400 associated with one searcher profile from those associated with other searcher profiles.

The profile searcher ID field 410 contains information of a searcher associated with the searcher profile record 400. The profile searcher ID field 410 may be used to ‘look up’ profile information associated with a searcher. Any number of searcher profile records may be associated with a searcher ID. Using the example in FIG. 4, the guide ‘PauIF 1126’ is associated with the profile ‘Searcher profile1’.

The searcher demographic profile data field 415 includes demographic information of a searcher associated with the searcher profile record 400. The demographic information may include, but is not limited to age, date of birth, educational background, gender, ethnicity, religious affiliation, political affiliation, height, weight, body type, etc. that may be associated with a searcher.

The searcher geographic profile field 420 includes geographic location information of a searcher associated with the searcher profile record 400. The geographic information may include, but is not limited to street address, IP address, GPS location information, telephone number, previous addresses, work address, zip code, etc. that may be associated with a searcher.

The searcher personality profile field 425 includes information regarding personality characteristics of a guide or searcher associated with the searcher profile record 400. The information may include but is not limited to psychometric profile information, personal perspective data, etc. which may be associated with a searcher.

The searcher interest area profile field 430 includes information regarding interest areas for a searcher associated with the searcher profile record 400. The interest area information may include, but is not limited to topics of articles or other publications, self-expressed areas of interest, hobbies, affiliations with organizations or companies, membership in clubs, blogs, etc. which may be associated with a searcher. Exemplary profile data is presented in the example record illustrated in FIG. 4, but other information and additional fields may be utilized within the scope of the embodiments described herein.

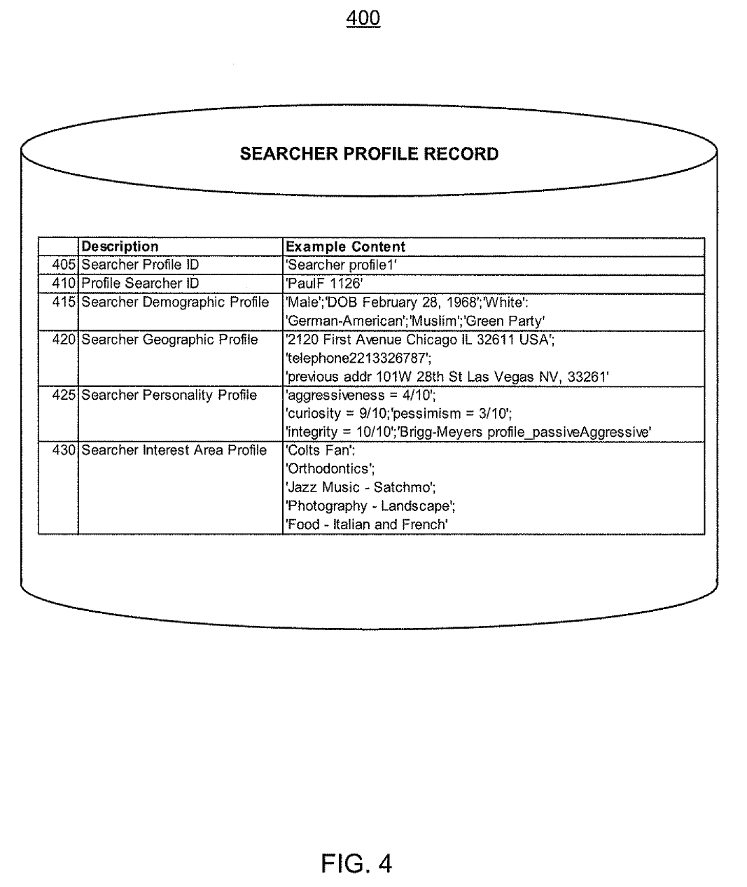

As illustrated in FIG. 5, an exemplary user profile record 500 of which one or more may be associated with or resident in the search system database 120 (FIG. 1) is provided. The user profile record 500 may comprise a user profile identifier (ID) field 505, a profile user ID field 510, a user demographic profile field 515, a user geographic profile field 520, a user personality profile field 525, and a user interest area profile field 530.

The user profile ID field 505 contains an identifier of the user profile record 500. The user profile ID is preferably unique and is used consistently to identify a user profile. The user profile ID field 505 may contain text and/or numeric information and may contain information based on a random number. The user profile ID field 505 serves to distinguish the user profile record 500 associated with one user profile from those associated with other user profiles.

The profile user ID field 510 contains information of a user associated with the user profile record 500. The profile user ID field may be used to ‘look up’ profile information associated with a user. Any number of user profile records may be associated with a user ID. Using the example in FIG. 5, the user ‘Bill Barnes’ is associated with the profile ‘User profile1’.

The user demographic profile field 515 includes demographic information of a user associated with the user profile record 500. The demographic information may include, but is not limited to age, date of birth, educational background, gender, ethnicity, religious affiliation, political affiliation, height, weight, body type, etc. that may be associated with a user.

The user geographic profile field 520 includes geographic information of a user associated with the user profile record 500. The geographic information may include, but is not limited to street address, IP address, GPS location information, telephone number, previous addresses, work address, zip code, etc. that may be associated with a user.

The user personality profile field 525 (FIG. 5) includes information regarding personality characteristics of a user associated with the user profile record 500. The information may include but is not limited to psychometric profile information, personal perspective data, etc., which may be associated with a user.

The user interest area profile field 530 includes information regarding interest areas of a user associated with the user profile record 500. The interest area information may include but is not limited to topics of articles or other publications, self-expressed areas of interest, hobbies, affiliations with organizations or companies, membership in clubs, etc. which may be associated with a user.

The searcher profile record 400 (FIG. 4) and the user profile record 500 (FIG. 5) may comprise other fields within the scope of the embodiments described herein. One of ordinary skill in the relevant art will immediately recognize that information of other characteristics of a guide and/or user may be included in a searcher and/or user profile to facilitate selection of a user(s), a guide(s) (searcher), a search result(s) and/or other information based on the content of a profile.

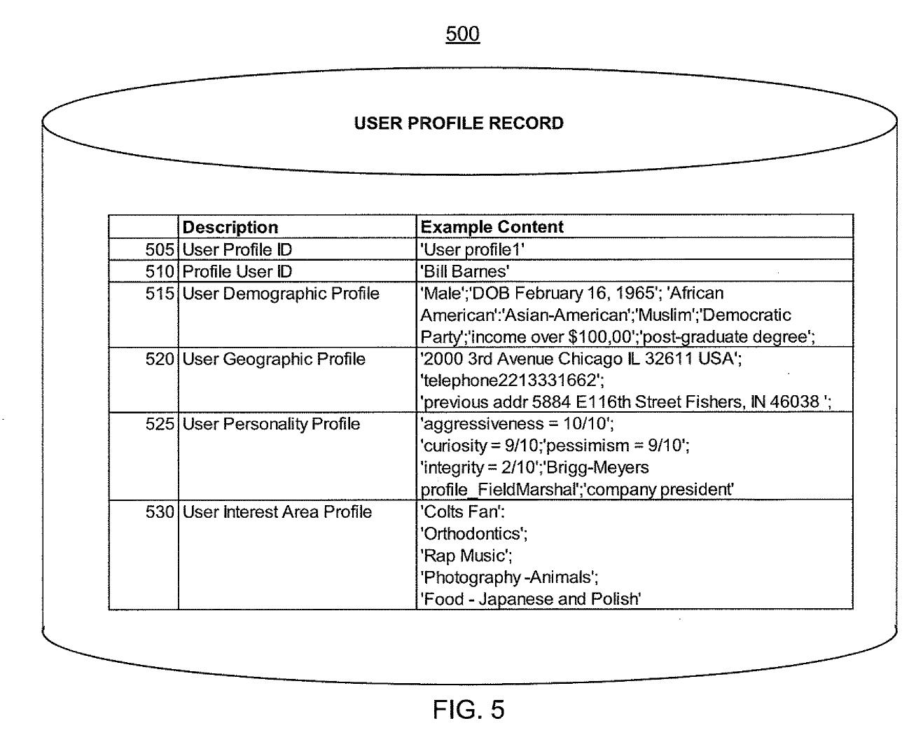

As illustrated in FIG. 6, a process 600 of obtaining information of a profile by designating a resource(s) is provided.

In operation 605 a determination is made as to whether a profile access request has been received. If it is determined that no access request has been received, control remains at operation 605 and process 600 continues to wait. If it is determined in operation 605 that a valid request to access a profile has been received, control is passed to operation 610 and process 600 continues.

In operation 610 a determination is made as to whether a resource(s) to be used to obtain profile data is identified. If in operation 610 it is determined that no resource(s) is identified, control is passed to operation 625 and process 600 continues. If in operation 610 it is determined that a resource(s) is identified, control is passed to operation 615 and process 600 continues.

A resource(s) identified in operation 610 may include, but is not limited to, items such as published articles, a blog website, a collection of photos, information accessible on a personal hard drive, a music file(s), a video file(s), a group of favorites or URL's, an online resource such as a MySpace® or Facebook® page, a spreadsheet, a multimedia presentation, a computer program, a profile from a site such as LinkedIn®, a search log associated with a person, etc. In other words, any information which may be identified and accessed by the system 100 (FIG. 1).

In operation 615 a resource(s) identified in operation 610 is processed to obtain information for a profile accessed in operation 605. The processing may include, but is not limited to, processes such as scanning a document(s) to extract a keyword(s) from the document(s), analysis of a web page(s) to determine relevant content, review of tags, metadata and/or content of image, audio, video and/or mixed media, analysis of content of information associated with a search activity and/or other transaction(s) or service(s). For example, content of a collection of music might be analyzed to determine content of a profile, or content of queries associated with a user might be analyzed by a guide in order to determine profile information. Content of a file(s) associated with a communication service(s) such as email, Instant Messaging (IM), text and/or media messaging, voice, etc. may be processed. For example, a list of contacts might be analyzed to determine geographic information and/or demographic information of a profile. URLs may be processed in order to obtain profile information. For example, a number of URL's associated with a person may be compared to a database of URL's which may be associated information of a given profile. The processing may include automated analysis and/or may utilize a human assistant(s) and may include multiple processes. Control is passed to operation 620 and process 600 continues.

In operation 620 a profile is updated. The update operation may include creating, adding, and/or removing information from a profile, and/or modification of other information contained in the search system database 120 (FIG. 1). For example a record such as the user profile record 400 (FIG. 4) and/or the guide profile record 500 (FIG. 5) may be created and/or modified. In at least one embodiment, information of a profile may be modified, but is not deleted. Control is passed to operation 625 and process 600 continues.

In operation 625 a determination is made as to whether a profile may be edited. If in operation 625 it is determined that a profile may not be edited, control is passed to operation 605 and process 600 continues. If in operation 625 it is determined that a profile may be edited, control is passed to operation 630 and process 600 continues. The determination in operation 625 may be made based upon various criteria. For example, depending on the nature of a resource(s) identified in operation 610, editing of information obtained utilizing the resource(s) may or may not be allowed by the search system 130 (FIG. 1). For example, if a resource is a database of degrees earned or certifications received, modification of the associated profile data may not be allowed. In at least one embodiment, the search system 130 may offer a person an option to modify a profile, which may be declined.

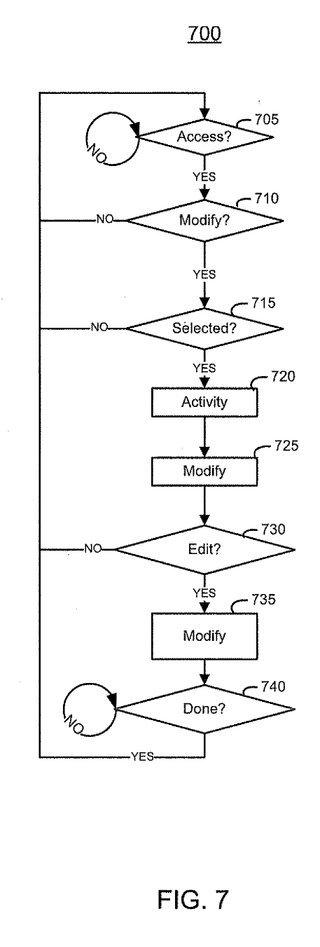

In operation 630 a person, such as a user, a guide, or a system administrator may modify the information of a profile, which may have been obtained in operation 620. An exemplary GUI for review of information of a profile is illustrated in FIG. 8. Using a GUI, such as the GUI 800 illustrated in FIG. 8, or any other suitable means, a modification(s) may be made to a profile (e.g., the searcher profile record 400 (FIG. 4), or the user profile record 500 (FIG. 5)). Control is passed to operation 635 and process 600 continues.

In operation 635 a determination is made as to whether profile modification is complete. If it is determined in operation 635 that profile modification is complete, the search database 120 (FIG. 1) is updated, control is passed to operation 605 and process 600 continues. If it is determined that profile modification is not complete, control remains at operation 635 and process 600 continues to wait.

The determination in operation 635 may be made based on any suitable indication of completion, such as activation of a control, a time-out, etc.

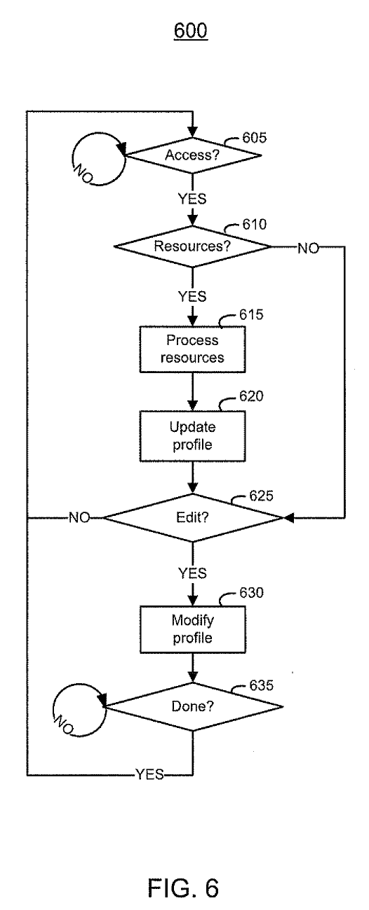

As illustrated in FIG. 7, a process 700 of creation and/or modification (management) of a user and/or guide profile based on participation in an interactive session is provided.

In operation 705 a determination is made as to whether a profile access request has been received. If it is determined in operation 705 that an access request has not been received, control remains at operation 705 and process 700 continues to wait. If it is determined in operation 705 that an access request has been received, control is passed to operation 710 and process 700 continues.

In operation 710 a determination is made as to whether a profile is to be modified using an interactive session. If it is determined in operation 710 that a profile is not to be modified using an interactive session, control is passed to operation 705 and process 700 continues. If it is determined in operation 710 that a profile is to be modified using an interactive session, control is passed to operation 715 and process 700 continues.

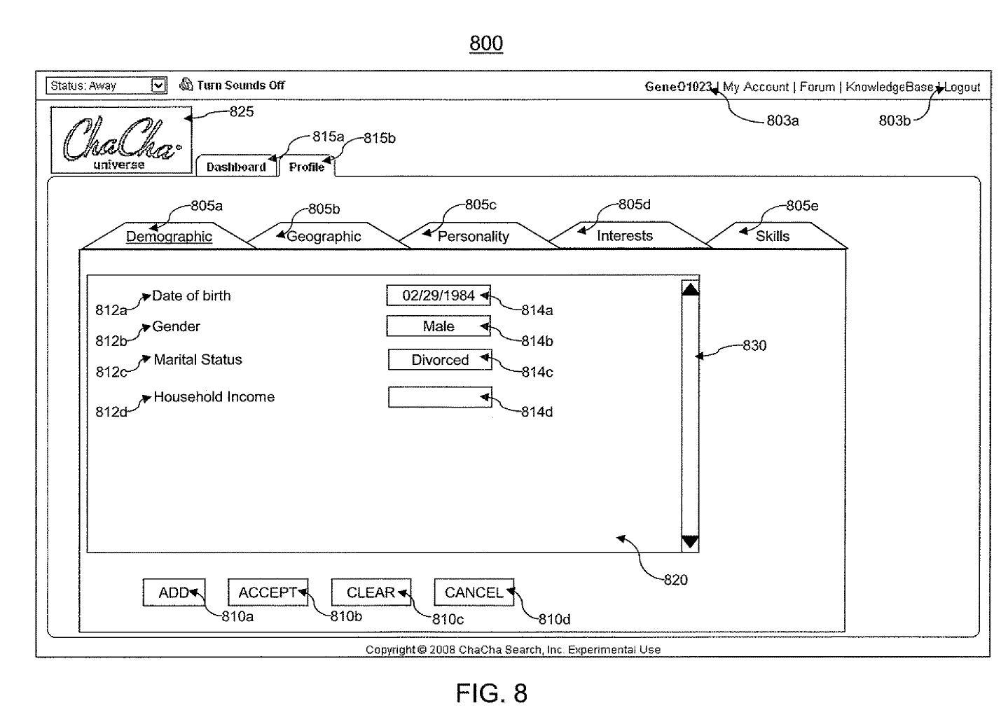

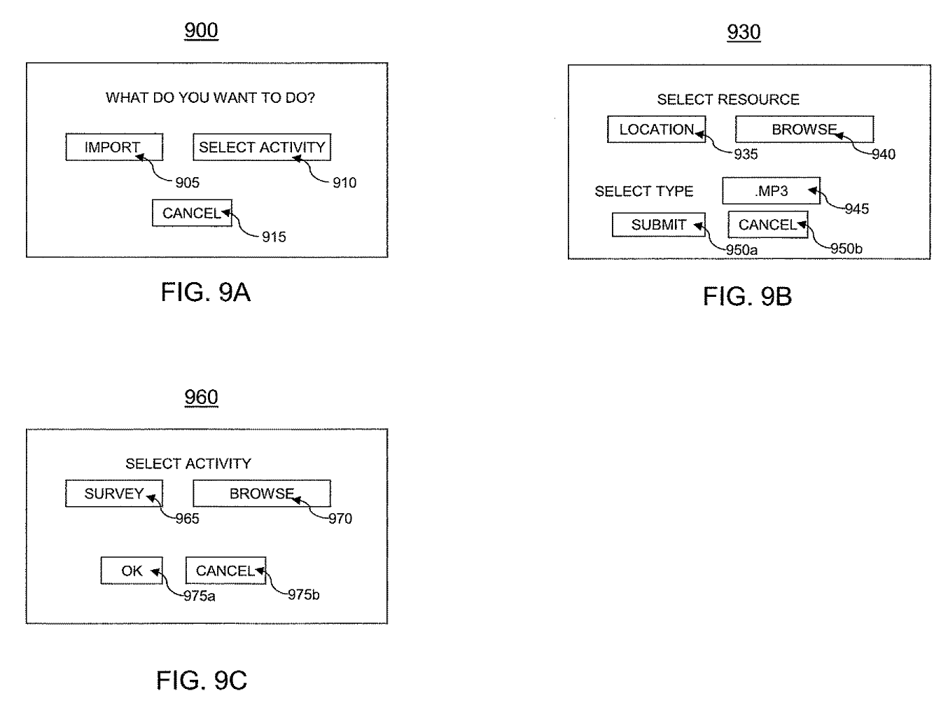

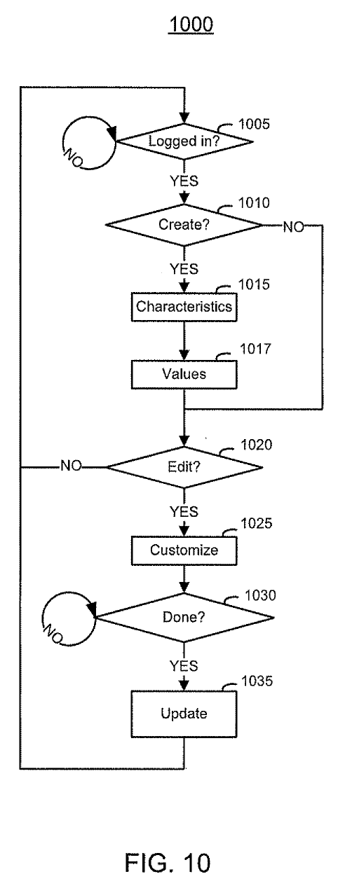

The determination in operation 710 may be made based on various criteria. In at least one embodiment, the availability of an activity may be based on the eligibility of a person to participate in a form of training or testing. In at least one embodiment, a user and/or a searcher may be offered an option to participate in an interactive session, such as a poll, a survey, etc. If the user or guide declines to participate, it may be determined that a profile is not to be modified using an interactive session. In at least one embodiment, an interactive session may be initiated without explicit action by a person(s). The search system 130 (FIG. 1) may select an activity based on information indicated in the search database 120 (FIG. 1). For example, an interactive session(s) may be offered to a guide based on completion of a training activities, a number of searches completed, and/or other information associated with the guide, or based on information in a profile (e.g., a predetermined number of users associated with a profile), or other information indicated in the search system database 120 (FIG. 1). An exemplary GUI for selecting an activity is illustrated in FIG. 9B.

In operation 715 a determination is made as to whether an interactive session is selected. If it is determined in operation 715 that an interactive session is not selected, control is passed to operation 705 and process 700 continues. If it is determined in operation 715 that an interactive session is selected, control is passed to operation 720 and process 700 continues.

The determination in operation 715 may be made based on various criteria. In at least one embodiment, a list of available interactive session(s) may be presented to a person and if the person does not make a selection in a pre-determined time period, or actively declines to make a selection, it may be determined that an interactive session is not selected, or if the person selects an item from the list, it may be determined that an interactive session is selected. In at least one embodiment, a person may not be offered an option regarding selection of an interactive session, and the search system 130 (FIG. 1) may select an interactive session(s) for the person, in which case the determination in operation 715 is made by the search system 130 (FIG. 1). In at least one embodiment, a guide or a user may be required to participate in an interactive session(s) to provide profile information. For example, a guide might be required to demonstrate knowledge of a location, a topic, a person, a company, a type of music, a sport, a hobby, a type of food, etc. in order to have information associated it included in the guide's profile.

In operation 720 an interactive session(s) is conducted which may be used to obtain information of a person(s). An interactive session may include but is not limited to a survey, a game, a test, a puzzle, an interactive training, a search session, or any activity which may be used to provide profile information to the search system 130 (FIG. 1). For example a personality survey and/or test might be utilized to obtain personality information of a profile, or a game which may determine knowledge of a location, or a topic such as a trivia game might be provided, or interactive training using information of a search sessions and/or the participation of one or more guide(s) or other persons might be provided, or a search activity associated with a persons who are associated with a profile might be conducted. Control is passed to operation 725 and process 700 continues.

In operation 725, a result(s) of an interactive session(s) conducted in operation 720 is processed and may be used to modify a profile(s) accessed in operation 705. The processing may include evaluating a test, receiving a rating(s) from a participant(s) in an interactive session, comparison of a survey result(s), analysis of a search session log, etc. The modification of a profile may include adding information to existing fields of and/or creating additional fields in a profile record and/or other information indicated in the search database 120 (FIG. 1). Preferably, information may not be deleted from the search system database 120, but information may be added to it. Control is passed to operation 730 and process 700 continues

In operation 730 a determination is made as to whether a person accessing a profile may modify (edit) the profile. If it is determined in operation 730 that a profile may not be modified, control is passed to operation 705 and process 700 continues. If it is determined in operation 730 that a profile may be modified, control is passed to operation 735 and process 700 continues.

The determination in operation 730 may be made based on various criteria. For example, if a test has been administered to determine profile information, modification of the profile information obtained may not be allowed. If an activity has been performed which is optional, such as an opinion survey or a personality profile test a person may be allowed to delete and/or otherwise modify information obtained. Access rights to modify any or all content of a profile may be determined according to the type of profile information by the search system 130.

In operation 735 information of a profile is modified. An exemplary GUI for review of a profile(s) is illustrated in FIG. 8. Using a GUI, such as the GUI 800 illustrated in FIG. 8, or any suitable means, a modification(s) may be made to a profile (e.g., the searcher profile record 400 (FIG. 4), or the user profile record 500 (FIG. 5)). Control is passed to operation 740 and process 700 continues.

In operation 740 a determination is made as to whether profile modification is complete. If it is determined in operation 740 that profile modification is complete, the search database 120 (FIG. 1) is updated, control is passed to operation 705 and process 700 continues. If it is determined that profile modification is not complete, control remains at operation 740 and process 700 continues to wait.

The determination in operation 740 may be made based on any suitable indication of completion, such as activation of a control, a time-out, etc.

An exemplary GUI 800 for reviewing and/or editing information included in a profile is illustrated in FIG. 8.

The GUI 800 may include user activity indicators 803, information selection tabs 805, action controls 810, profile information identifiers 812, profile information indicators 814, activity selection tabs 815, an information display window 820, an advertising window 825, and navigation controls 830.

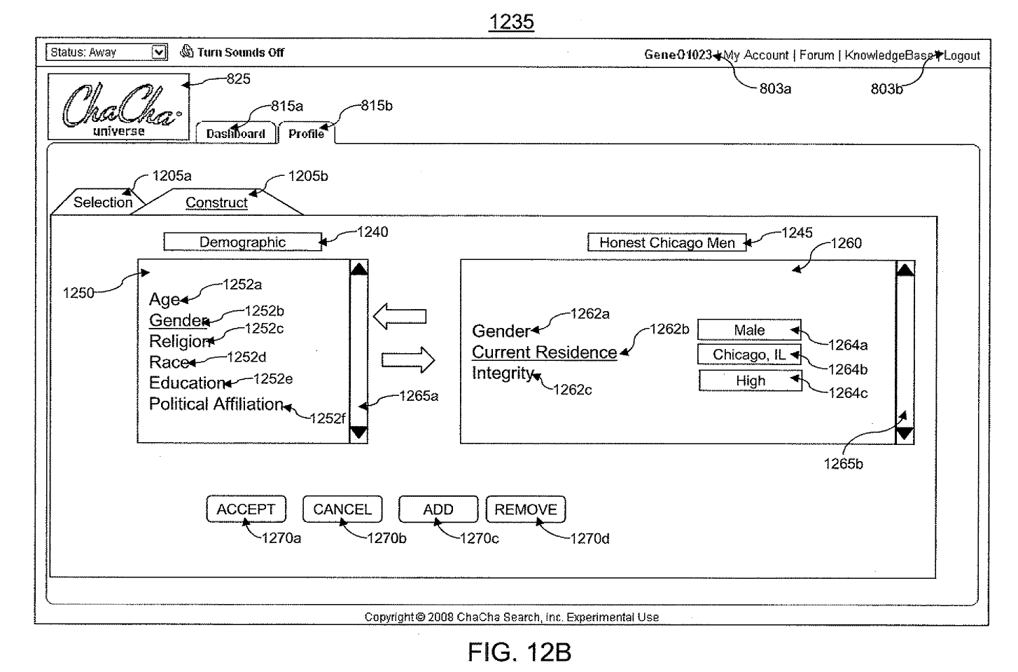

The activity indicators 803 may be used to provide a selection of user activities. Selection of an option may result in activation of the activity indicator 803a and may cause the GUI 800 to be presented. The activity indicator 803b may be used to log in or log out of the search system 130 (FIG. 1). The activity selection tabs 815 may be used to cause a corresponding GUI to be provided. Selection of the ‘Dashboard’ activity selection tab 815a may cause a GUI for managing profiles such as the GUI 1200 illustrated in FIG. 12A to be provided. Selection of the ‘Profile’ activity selection tab 815b may cause the GUI 800 to be presented. The advertising window 825 may be used to present an advertisement. The content of the advertisement window may be modified based on information indicated in the GUI 800. Any number of advertising windows may be presented in the GUI 800.

The information selection tabs 805 may be used to select information of a profile. For example, the ‘Demographic’ information selection tab 805a may be used to cause demographic information of a profile to be presented in the information display window 820. Likewise, the information selection tabs 805b, 805c, 805d, 805e respectively may be used to cause ‘Geographic’, ‘Personality’, ‘Interests’, and ‘Skills’ information of a profile to the presented in the information display window 820. Any number of information selection tabs may be provided in the GUI 800 according to the organization of groups of characteristics in a profile.

The profile information identifiers 812 may identify a type of information contained in a profile. A profile information indicator may indicate content of a profile associated with a profile information identifier. In at least one embodiment, a number of the profile information indicators 814 may be used to provide information. In at least one embodiment, a number of profile information indicators 814 may require specific access rights in order to modify information indicated in the profile information indicators 814. The ‘Date of birth’ profile information identifier 812a identifies the date of birth information indicated in the profile information indicator 814a. The ‘Gender’ profile information identifier 812b identifies the gender information indicated in the profile information indicator 814b. The ‘Marital Status’ profile information identifier 812c identifies the marital status information indicated in the profile information indicator 814c. The ‘Household Income’ profile information identifier 812d identifies the null information indicated in the profile information indicator 814d. A blank profile information indicator may indicate that the information identified in the relevant profile information identifier is not available in the search database 120 (FIG. 1). Any number of profile information identifiers and profile information indicators needed to operate the embodiments may be provided. The profile information indicators 814 have been depicted as text boxes, but might also be implemented as drop-down lists or other controls well known in the relevant art.

The action controls 810 may be used to take actions regarding information indicated in the GUI 800. The ‘ADD’ action control 810a may cause a GUI such as the GUI 900 illustrated in FIG. 9A to be provided. The ‘ACCEPT’ action control 810b may cause information provided using the GUI 800 to be recorded in the search database 120 (FIG. 1). The ‘CLEAR’ action control 810c may cause the content of the profile information indicators in the information display window 820 to be cleared. The ‘CANCEL’ action control 810d may cause the information provided using the GUI 800 to be discarded. The navigation controls 830 may be used to scroll through information indicated in the information display window 820.

A GUI 900 for selecting a source for providing information to be included in a profile is illustrated in FIG. 9A. The GUI 900 may include an import selection control 905, an activity selection control 910 and a cancel control 915. Activation of the import selection control 905 may cause a GUI such as the GUI 930 illustrated in FIG. 9B to be provided. Activation of the activity selection control 910 may cause a GUI such as the GUI 960 illustrated in FIG. 9C to be provided. Activation of the cancel control 915 may close the GUI 900 and/or return to a previous GUI, The GUI 900 may be presented as a ‘pop-up’ in the GUI 800 (FIG. 8).

A GUI 930 for selecting information to be incorporated into a profile is illustrated in FIG. 9B. The GUI 930 may include a location indicator 935, a browse control 940, a type selection control 945, and action controls 950.

The location indicator 935 may be used to indicate a location where a resource to be processed to provide information of a profile may be found. For example, a Uniform Resource Locator (URL), or other information which may identify a resource such as a file, web page, or other resource may be indicated using the location indicator 935. The browse control 940 may be used to activate a browsing function (not shown), as is well known in the relevant art which may be used to locate a file or directory on local storage of a device such a disk drive, removable storage, etc., or to locate a URL via a web browsing functionality. Alternately, a URL might be ‘cut and pasted’ into the location indicator 935. The type selection control 945 may be used to designate a file type(s) which are to be processed at a location indicated in the location indicator 935. In at least one embodiment, a file type(s) may be automatically detected. Activation of the ‘Submit’ action control 950a may cause a resource(s) indicated in the location indicator 935 to be processed in order to provide information to be included in a profile. Activation of the ‘Cancel’ action control 950b may close the GUI 930.

A GUI 960 for selecting an activity for providing information of a profile is illustrated in FIG. 9C. The GUI 960 may include an activity selection control 965, an activity browsing control 970, and action controls 975. The activity selection control 965 may be used to select an activity to be performed. For example, a drop-down list of activities which may be used to provide profile information may be provided. The activity browsing control 970 may activate a web page (not shown) which may present information of activities available to provide information of a profile. In at least one embodiment, the available activities may be based on information of a searcher indicated in the search database 120 (FIG. 1). Activation of the ‘OK’ action control 975a may initiate an activity which is indicated in the activity selection control 965. Activation of the ‘Cancel’ action control 975b may close the GUI 960.

While specific types of interface controls have been used for the purposes of illustration, one of ordinary skill in the relevant art will immediately recognize that other interface controls well known in the relevant art may be used to implement the GUIs 800 (FIG. 8), 900 (FIG. 9A), 930 (FIG. 9B), and 960 (FIG. 9C).

In at least one embodiment, a user may create a profile which is based on information related to a guide(s) registered with the search system 130 (FIG. 1). For example, if a number of guides have participated in an activity such as a skills test, a demographic profile, a personality evaluation test, or have related information indicated in a profile record such as the searcher profile record 400 (FIG. 4), a group of guides with a set of characteristics may be identified. If such a condition exists, a person may be able to create, edit, select and/or otherwise employ a profile(s) which is related to one or more characteristics in order to designate a profile(s) which may correspond to one or more guides and/or users. In at least one embodiment, a person may be presented with a GUI such as the GUI 800 (FIG. 8) which may allow the person to create, edit and/or select a ‘parametric’ profile or profile which is not specifically related to any person based at least in part on information indicated in the search system database 120 (FIG. 1).

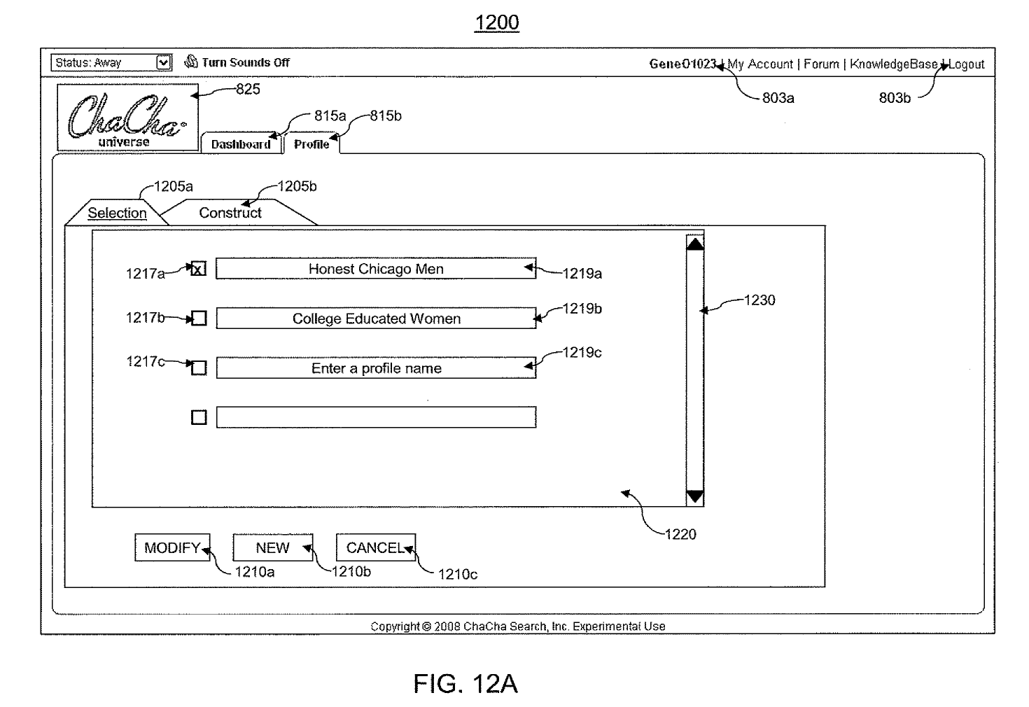

For example, one or more guides may participate in an activity such as a personality survey (e.g., eHarmony® personality evaluation), may fill out a survey form, may indicate files which have similar information content, etc. A profile may be created which may identify one or more persons based upon matching of data indicated in a field(s) in a searcher and/or user profile(s) with information indicated in a profile(s) such as the parametric profile record 1100 as described in further detail with respect to FIG. 11.

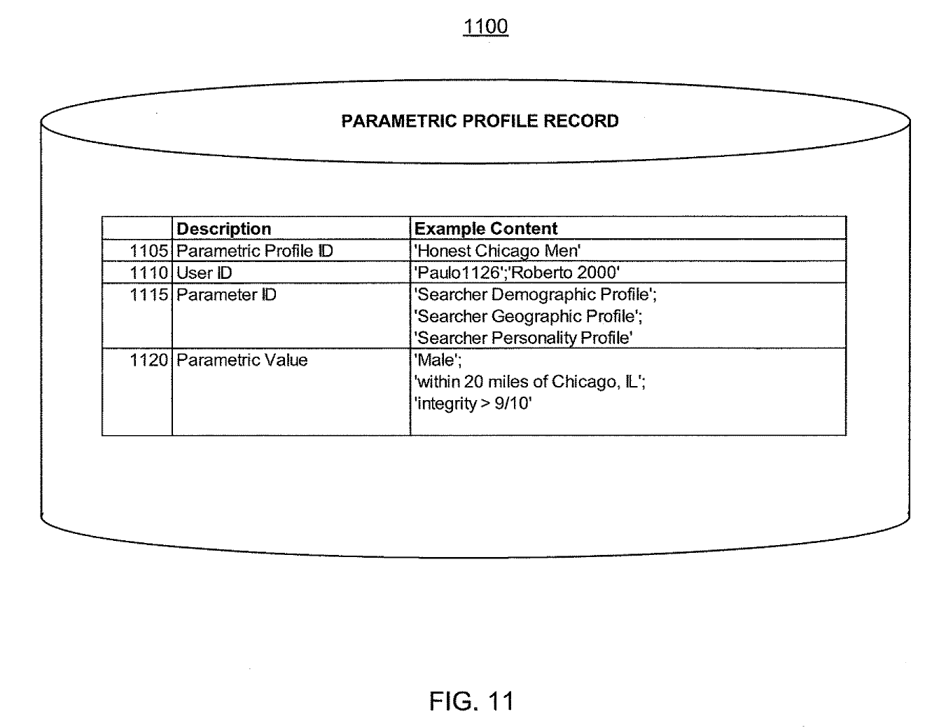

As illustrated in FIG. 10, a process 1000 of creating and/or editing of a parametric profile is provided.

In operation 1005 a determination is made as to whether a person is logged-in. If in operation 1005 it is determined that a person is not logged-in, control remains with operation 1005 and process 1000 continues. If it is determined in operation 1005 that a person is logged-in, control is passed to operation 1010 and process 1000 continues.

In operation 1010 a determination is made as to whether a profile is to be created. If it is determined in operation 1010 that a profile is to be created, control is passed to operation 1015 and process 1000 continues. If it is determined that a profile is not to be created, control is passed to operation 1020 and process 1000 continues.

The determination in operation 1010 may be made based on criteria such as activation of an action button in a GUI, activation of a keypad button on a mobile device, a system condition being met, etc.

In operation 1015 a selection is made of information of parameters that may be used to create a profile(s). The selection may include presentation of information of a characteristic(s) of a guide(s) and/or an information seeker(s). A GUI such as the GUI 1235 illustrated in FIG. 12B may be used to select characteristics. A parametric profile may be created by selecting characteristics which may be matched. For example, a user might be presented with information regarding characteristics included in the user's profile, or a user might be presented with a list of characteristics which are obtained using a survey, a test, a processed resource(s) (e.g., a registration form, or a published work), etc. The search system 130 (FIG. 1) might select a characteristic(s) based on information indicated in the search system database 120. Any characteristic(s) indicated in the search system database 120 may be included in a parametric profile. Selection of characteristics may be done by system administrators. Control is passed to operation 1017 and process 1000 continues.

In operation 1017 a value or range of values for a characteristic(s) identified in operation 1015 is selected. A value or range of values may be determined using various methods. For example, a person may be presented with check boxes or ‘slide’ indicators or other types of selection controls. A person may select a value and/or range of values for a characteristic(s) identified in operation 1015. A selected value(s) may be based on other information. For example, a selected value(s) may be set to a default value which is the opposite of a person's profile (e.g., if the person is male, the default value is female, or if a person is conservative, the default value is liberal). A selected value or range of values may be determined based on a calculation(s) performed by the search system 130 (FIG. 1). A system administrator(s) may select a value or range of values. A value or range of values may be selected based on calculations (determination) based on any information in the search system database 120 (FIG. 1). For example a median, mean, or other arithmetic value based on information in a group of profiles may be selected. Any suitable criteria may be used to establish a value or range of values for a characteristic(s) in a parametric profile. Control is passed to operation 1020 and process 1000 continues.

In operation 1020 a determination is made as to whether a parametric profile is to be edited. In at least one embodiment a parametric profile record such as the parametric profile record 1100 illustrated in FIG. 11 may be created and/or associated with the user ID of a user identified in operation 1005. If it is determined in operation 1020 that a parametric profile is not to be edited control is passed to operation 1005 and process 1000 continues. If it is determined in operation 1020 that a parametric profile is to be edited control is passed to operation 1025 and process 1000 continues.

The determination in operation 1020 may be made based on various criteria, such as selection of a profile from a list, activation of an action button, etc. In at least one embodiment, a list of parametric profiles may be presented, which may be selected for editing. An exemplary GUI for selecting a profile to be edited is illustrated in FIG. 12A.

In operation 1025 a parametric profile is edited. Editing may be done in various ways. For example, a GUI or a web page may be presented, a voicexML menu may be provided, or any other interface may be provided. An exemplary GUI for editing a parametric profile is illustrated in FIG. 12B. Control is passed to operation 1030 and process 1000 continues.

In operation 1030 a determination is made as to whether editing of a profile is complete. If in operation 1030 it is determined that editing of a profile is not complete, control remains at operation 1030 and process 1000 continues to wait. If in operation 1030 it is determined that editing of a profile is complete, control is passed to operation 1035 and process 1000 continues.

The determination in operation 1030 may be made based on various criteria such as activation of an action button, the expiration of a time period, receipt of a message, and/or other suitable completion criteria.

In operation 1035 the search system database 120 (FIG. 1) is updated. Information of a parametric profile may be stored, as well as information associated with editing and/or creation of the profile. Information of a user(s), a searcher(s), and/or a profile(s) may be recorded. Control is passed to operation 1005 and process 1000 continues.

A parametric profile such as the parametric profile record 1100 (FIG. 11) may be used for example, to select a guide(s) with a matching profile, to identify a search result(s) produced by one or more guides with a target set of characteristics to identify a group of one or more guides to participate in an activity(ies) such as voting, polling, etc. A parametric profile may be used to select any type of information such as a search result(s), a category(ies), a keyword(s), an advertisement(s), etc. which may be associated with profile information. An exemplary GUI(s) for creating and editing a profile is illustrated in FIGS. 12A and 12B.

In at least one embodiment, the process 1000 may be employed by an administrator(s) of the search system 100 (FIG. 1) to create parametric profiles which may be made available to a user(s) and/or a guide(s). This may reduce the need for a user(s) to create and/or edit a parametric profile(s), and may allow a profile to be more easily associated with a query.

A method for selecting a guide(s), a search result(s), and/or other item(s) using a profile are further described in the related U.S. Provisional Application Ser. No. 60/980,010 previously mentioned.

As illustrated in FIG. 11, an exemplary parametric profile record 1100 of which one or more may be associated with or resident in the search system database 120 (FIG. 1) is provided. The parametric profile record 1100 (FIG. 11) may comprise a parametric profile identification (ID) field 1105, a user ID field 1110, a parameter ID field 1115, and a parametric value field 1120.

The parametric profile ID field 1105 includes an identifier of the parametric profile record 1100. The parametric profile ID is preferably unique and is used consistently to identify a parametric profile record. The parametric profile ID field may contain text and/or numeric information and may contain information based on a random number. The parametric profile ID field 1105 serves to distinguish the parametric profile record 1100 associated with one parametric profile from those associated with other parametric profile(s). Multiple parametric profile records may be comprised in the search system database 120 (FIG. 1).

The user ID field 1110 includes information of a user ID(s) associated with the parametric profile record 1100. The user ID field information may be used to identify a user(s) associated with the parametric profile record 1100. Using this association, the search system 130 (FIG. 1) may identify a parametric profile record(s) which is associated with a user. Any number of parametric profile records may be associated with a user(s).

The parameter ID field 1115 includes information regarding the information within a profile(s) which is associated with the parametric profile record 1100. The parametric value field 1120 includes information of a value or range of values to be matched in a field indicated by the parameter ID field 1115 in a profile(s) such as the searcher profile record 400 (FIG. 4). The parameter ID field 1115 (FIG. 11) may for example, indicate one or more fields in a searcher profile which may contain information which may be compared to information indicated in the parametric value field 1120 of a parametric profile record 1100. Using the example illustrated in FIG. 11, the parameter ID field 1115 indicates that information indicated in the searcher demographic profile field 415 (FIG. 4) of a searcher profile record is to be used to match the value ‘Male’ as indicated in the parametric value field 1120. Using the same example, the information in the searcher geographic profile field 420 may be examined to determine if a guide profile indicates that a guide is ‘within 20 miles of Chicago, Ill.’ and the searcher personality data field 425 may be examined to find ‘integrity>9/10’. In at least one embodiment, the parameter ID field 1115 and the parametric value field 1120 are linked by, for example, a pointer. While the parametric profile record 1100 is illustrated using the specific examples in FIG. 11 and FIG. 4, it will be immediately obvious to one of ordinary skill in the relevant art that other means of identifying data associated with a profile(s) and comparing it to information indicated in a parametric profile(s) may be employed without departing from the scope and spirit of the embodiments disclosed herein.

Using a parametric profile(s) such as the parametric profile record 1100 and a searcher profile(s) such as the searcher profile record 400 (FIG. 4) a group of searcher(s) may be selected. A selected group may include any number of searchers. The information indicated in a group of profile records may be used to identify a group of any number of persons associated with a profile.

The searcher profile record 400 (FIG. 4), the user profile record 500 (FIG. 5) and the parametric profile record 1100 (FIG. 11) may comprise other fields within the scope of the embodiments described herein. One of ordinary skill in the relevant art will immediately recognize that information of other characteristics of a guide and/or user may be included in fields of a searcher and/or user profile to facilitate selection of a user(s), a guide(s), a search result(s), advertisement(s), etc. based on the content of a profile. Likewise, fields of a profile record may be blank.

An exemplary GUI 1200 for creating a parametric profile is illustrated in FIG. 12A.

The GUI 1200 may include user activity indicators 803, information selection tabs 1205, action controls 1210, activity selection tabs 815, profile selection controls 1217, profile name indicators 1219, a profile display window 1220, an advertising window 825, and navigation controls 1230.

The activity indicators 803 may be used to select activities. Selection of an option may cause activation of the activity indicator 803a to be presented. The activity indicator 803b may be used to log in or log out of the search system 130 (FIG. 1). The activity selection tabs 815 may be used to cause a GUI to be provided. Selection of the ‘Dashboard’ activity selection tab 815a may cause a GUI such as the GUI 1200 to be provided. Selection of the ‘Profile’ activity selection tab 815b may cause the GUI 800 (FIG. 8) to be presented. The advertising window 825 may be used to present an advertisement. The content of the advertising window 825 may be modified based on information indicated in the GUI 1200. Any number of advertising windows may be presented in the GUI 1200.

The information selection tabs 1205 may be used to indicate an activity in progress. The ‘Selection’ activity selection tab 1205a may be used to cause the GUI 1200 to be presented. The ‘Construct’ activity selection tab 1205b may be used to cause the GUI 1235 illustrated in FIG. 12B to be provided.

The profile display window 1220 may display information of profiles available in the search database 120 (FIG. 1). The profile selection controls 1217 may be used to select a profile. The profile name indicators 1219 may be used to indicate a name associated with a profile. The profile selection control 1217a may be used to select the profile ‘Honest Chicago Men’ as indicated in the profile name indicator 1219a. The profile selection control 1217b may be used to select the profile ‘College Educated Women’ as indicated in the profile name indicator 1219b. The profile selection control 1217c may be used to select the profile which may be entered in the profile name indicator 1219c.

The ‘MODIFY’ action button 1210a may cause the GUI 1235 illustrated in FIG. 12B to be provided for the selected profile. The ‘NEW’ action control 1210b may cause a profile selection control 1217 and a profile name indicator 1219 to be added to the profile display window 1220. The ‘CANCEL’ action button 1210c may close the GUI 1200. The navigation controls 1230 may be used to scroll through the content of the profile display window 1220.

An exemplary GUI 1235 for defining content of a parametric profile is illustrated in FIG. 12B.

The GUI 1235 may include a profile type selection control 1240, a profile name indicator 1245, a profile parameter selection window 1250, a profile content window 1260, and action controls 1270.

The profile type selection control 1240 may be used to indicate a type of profile parameters displayed in the profile parameter selection window 1250. The profile type selection control 1240 may be implemented as a dropdown list of types of parameters which may be included in a profile. For example, any or all of the list of the profile types indicated in the information selection tabs 805 (FIG. 8) may be provided. Changing the content of the profile type selection control 1240 may modify the profile parameter selection controls 1252 displayed in the parameter selection window 1250. The profile name indicator 1245 may be used to indicate a profile name associated with the profile parameters indicated in the profile content window 1260.

The profile parameter selection controls 1252 may be used to indicate available profile parameters which may be transferred to the profile content window 1260. The profile parameter selection control 1252a may be used to select the ‘Age’ parameter, the profile parameter selection control 1252b may be used to select the ‘Gender’ parameter, the profile parameter selection control 1252c may be used to select the ‘Religion’ parameter, the profile parameter selection control 1252d may be used to select the ‘Race’ parameter, the profile parameter selection control 1252e may be used to select the ‘Education’ parameter, and the profile parameter selection control 1252f may be used to select the ‘Political Affiliation’ parameter. Selection may be indicated by for example the underling as indicated in the ‘Gender’ parameter selection control 1252b, but any type of indication may be used. A parameter may be transferred from the profile parameter selection window 1250 to the profile content window 1260 by for example ‘double-clicking’ on a profile parameter selection control 1252. The navigation control 1265a may be used to scroll through the content of the profile parameter selection window 1250.

The profile parameter content controls 1262 may be used to indicate the content of a profile indicated in the profile name indicator 1245. The profile parameter content controls 1262 may be used to select parameters indicated in the profile content window 1260. The profile parameter content control 1262a may be used to select the ‘Gender’ parameter, the profile parameter content control 1262b may be used to select the ‘Current Residence’ parameter, and the profile parameter selection control 1262c may be used to select the ‘Integrity’ parameter. Selection may be indicated by for example the underling as indicated in the ‘Current Residence’ parameter content control 1262b, but any type of indication may be used. A parameter may be removed from the profile content window 1260 by for example ‘double-clicking’ on a profile parameter content control 1262.

The parameter value indicators 1264 may be used to provide information associated with a parameter indicated in the profile parameter content controls 1262. The parameter value indicator 1264a may be used to select a value for the ‘Gender’ parameter. For example, a typing box or drop-down list or ‘radio’ buttons might be provided to select a value for the ‘Gender’ to be used in the profile ‘Honest Chicago Men’ as indicated in the profile name indicator 1245. The parameter value indicator 1264b may be used to indicate a value for the ‘Current Residence’ parameter. For example, as a location name is entered in the parameter value indicator 1264b, a suggested location may be provided based on a database of location names indicated in the search system database 120 (FIG. 1). The parameter value indicator 1264c may be used to indicate a value for the ‘Integrity’ parameter. For example, a ‘slider bar’ might be provided to indicate a desired value of integrity, or a drop-down list of discrete values allowed for ‘Integrity’ might be provided. The navigation control 1265b may be used to scroll through the content of the profile content window 1260.

The action controls 1270 may be used to take actions regarding information indicated in the GUI 1235. The ‘ACCEPT’ action control 1270a may cause the information indicated in the GUI 1235 to be recorded in the search system database 120 (FIG. 1). The ‘CANCEL’ action control 1270b may cause the information indicated in the GUI 1235 to be discarded. The ‘ADD’ action control 1270c may cause parameters selected using the profile parameter selection controls 1252 to be transferred to the profile content window 1260. The ‘REMOVE’ action control 1270d may cause parameters selected using the profile content selection controls 1262 to be removed from the profile content window 1260.

While the embodiments described herein have been explained using exemplary control elements the GUIs depicted are not limited to any particular type or configuration of interface controls. One of ordinary skill in the relevant art will immediately recognize that alternate interface controls which are well known in the art may be used within the spirit and scope of the embodiments disclosed herein.

Using the embodiments described herein, a user(s) and/or guide(s) registered with a human-assisted search system may create, modify and otherwise manage a profile(s). The information content of a profile may be created and/or modified by indicating a resource(s) which may be processed and/or by participating in an activity(ies) which may be used to identify and/or generate information which is associated with a profile(s). A profile(s) may be created and/or edited which is not associated with a person, which may be used to select a group of persons. A profile(s) may be created, edited, or modified by a system administrator(s).

A group of one or more characteristics which are associated with a person or ‘profile’ may be created.

While the method and system disclosed herein have been described in the context of a human-assisted search system, they may be practiced in other applications. Any system which associates persons or entities with each other might employ the methods and system described herein. For example, a system managing people providing services such as transcription, translation, customer service, or any other services might utilize the methods and system disclosed herein.

The many features and advantages of the claimed invention are apparent from the detailed specification and, thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A method of creating a profile, comprising:
capturing a characteristic of a person by parsing content identified with the person; and
generating a profile for the person based on said capturing and selecting data to be associated with a search based on the profile.

2. The method of claim 1, wherein said data is one of an advertisement, or a response to a query triggering the search.

3. A method of creating a profile of a person, comprising:
identifying a person;
obtaining information associated with the person;
processing the information to determine a characteristic of the person;
determining a rating of the person associated with the characteristic; and
associating the characteristic and the rating with an identifier of the person.

4. The method of claim 3, wherein the information is a query and an answer associated with the person and a human searcher.

5. The method of claim 3, wherein the person is a human searcher.

6. The method of claim 3, wherein the information is one or more of a document, a blog, a message, an email, a webpage, or a database selected by the person.

7. The method of claim 3, wherein the information is obtained by one or more of testing, game playing, training, or polling.

8. A method of creating a profile associated with a person, comprising;
identifying a person;
obtaining information of the person from a registration process which requires the person to provide a standard set of information;
obtaining information of the person by indexing documents identified by the person;
obtaining information of the person by testing;
obtaining information of the person from an external database;
obtaining information of the person from a query and an answer history associated with the person and a human searcher;
processing each information obtained to determine a characteristic associated with the person; and
providing a selective access to the characteristics.

9. A method of creating a profile, comprising:
obtaining information of a person and creating a profile for the person using the information obtained; and
modifying content of the profile based on interaction with the person.

10. The method of claim 9, wherein the information is obtained independent of an interaction with the person.

11. The method of claim 9, wherein the information is obtained from an existing profile.

12. The method of claim 9, wherein the person is a guide who has registered to conduct a search responsive to a query submitted by an information seeker.

13. The method of claim 9, wherein said obtaining includes one or more of extracting a keyword from a document, analyzing a web page, reviewing a tag, metadata and/or content of an image, audio, video and/or mixed media, and analyzing content of information associated with a search.

14. The method of claim 9, wherein said interaction is one of a survey, a game, a test, a puzzle, an interactive training, or a search session.

15. The method of claim 9, comprising:
determining whether any of guides registered to conduct searches have a profile matching the profile created; and
presenting an activity for each guide determined to have a matching profile based on said determining.

16. The method of claim 9, wherein a result of the activity is utilized in selecting data to be associated with the profile created.

17. The method of claim 16, wherein the data is one or more of a search result, a category, a keyword and an advertisement.

18. A computer readable medium having embodied therein a program for causing a computer to execute an operation for creating a profile, comprising:
capturing a characteristic of a person by parsing content identified with the person; and
generating a profile based on said capturing and selecting data to be associated with a search based on the profile of the person.

19. A method of creating a profile, comprising:
generating a profile of a first user including based on information captured while the user is engaged in an activity independent of a search; and
associating a query of the first user with a second user based on the profile generated.

20. The method of claim 19, wherein the first user is an information seeker and the second user is a human searcher registered to conduct a search.

21. The method of claim 19, wherein said information is captured without requiring interactive submission of the information by the user.

22. A system of creating a profile, comprising:
a device obtaining a characteristic of a person by parsing content identified with the person; and
a database storing a profile generated based on said capturing and selecting data to be associated with a search based on the profile of the person.
